(19) United States
(12) Patent Application Publication
(10) Pub. No.: US 2017/0370772 A1
(43) Pub. Date: Dec. 28, 2017

(54) LED SPECTROFLUOROMETER FOR ANALYSIS OF AN OBJECT

(71) Applicants: UNIVERSITE BORDEAUX MONTAIGNE, Pessac (FR); UNIVERSITE DE BORDEAUX, Bordeaux (FR); INSTITUT POLYTECHNIQUE DE BORDEAUX, Talence (FR); CENTRE NATIONAL DE LA RECHERCHE SCIENTIFIQUE, Paris (FR)

(72) Inventors: Aurelie MOUNIER, Pessac (FR); Floréal DANIEL, Bordeaux (FR); Sylvain LAZARE, Leognan (FR)

(21) Appl. No.: 15/539,282

(22) PCT Filed: Dec. 23, 2015
(86) PCT No.: PCT/FR2015/053744

§ 371 Date: Jun. 23, 2017

(30) Foreign Application Priority Data
Dec. 24, 2014 (FR) 1463318

(51) Int. Cl. G01J 3/10; G01J 3/44; G01N 21/64

(52) U.S. Cl. CPC G01J 3/10; G01N 21/645; G01J 3/4406; G01J 2003/106; G01N 2021/6419

(57) ABSTRACT

An LED spectrofluorometer (100) for analysis of an object (101) includes a light excitation element (11, 112, 113) suitable for illuminating a study zone (101B) of the object with an excitation light beam (1), and an optical routing element (121, 122, 123, 124) suitable for collecting a fluorescent light flux (2) emitted by the study zone excited by the excitation light beam and for routing the fluorescent light flux to an optical spectrometer (131) for analysis of the light spectrum thereof. The light excitation element includes a first light-emitting diode (111) and a second-light emitting diode (112), the first light-emitting diode emitting at a first wavelength (λ1) between 250 and 300 nm and the excitation light beam being formed from one or other of the light beams generated by each light-emitting diode.

The present invention generally relates to the field of optical metrology applied to artworks and to archaeological objects.

More particularly, it relates to a spectrofluorometer for analysis of an object including light excitation means adapted to illuminate a study zone of said object with an excitation light beam, and optical routing means adapted to collect a fluorescence light flux emitted by said study zone excited by the excitation light beam and to route said fluorescence light flux towards an optical spectrometer for analysis of the light spectrum of said flux.

Spectrofluorometry is a method of optical analysis that allows in particular characterizing the materials present at the surface of an object that is desired to be analysed, and also following the degradation of these materials over time.

The portable devices available on the market, for example the spectrofluorometers sold by the Ocean Optics, Aventès or SteelarNet Companies, allow working on objects of small size or deposited on microscope slides.

These devices hence do not allow studying fragile artworks, for which the taking of samples from the object or the moving of the object to a laboratory of analysis is not possible.

Moreover, the known spectrofluorometers are often bulky, heavy, not very compact, and sometimes require a contact between the object to be analysed and the light excitation means, which may be prejudicial for the object.

In order to remedy the above-mentioned drawbacks of the state of the art, the present invention proposes a spectrofluorometer that is particularly compact, easily transportable, and adapted to the study of artworks and of archaeological objects.

More particularly, it is proposed according to the invention a spectrofluorometer as defined in introduction, in which the light excitation means comprise a first electroluminescent diode and a second electroluminescent diode, said excitation light beam being formed of one and/or the other light beam generated by each electroluminescent diode.

Hence, thanks to the use of electroluminescent diodes that are light sources of reduced size, the light excitation means have a reduced bulk and weight, so that the spectrofluorometer according to the invention is compact and transportable.

The electroluminescent diodes may also comprise their own optical focusing system directly integrated, so that no additional optical element is necessary to focus the excitation light beam to the surface of the object.

Moreover, the electroluminescent diodes are sources supplied with low voltage and may either be cell-operated, battery-operated, or power-supplied via the USB (Universal Serial Bus) port of a portable electronic device, so that the spectrofluorometer can be used with no external power supply for the light excitation means.

Finally, the electroluminescent diodes are little expensive components, so that the spectrofluorometer according to the invention has a low cost price.

Advantageously, the first electroluminescent diode of the spectrofluorometer according to the invention emits at a first wavelength comprised between 250 and 300 nm, this first wavelength being particularly adapted to the study of the organic materials present in the artworks or the archaeological objects.

Also advantageously, the second electroluminescent diode emits at a second wavelength comprised between 300 and 500 nm.

Other non-limitative and advantageous characteristics of the spectrofluorometer according to the invention are the following:
said light excitation means comprise a first focusing lens to focus said excitation light beam to a surface of said object;
said optical routing means comprise a second focusing lens to route the fluorescence light flux collected towards an entry of said optical spectrometer;
said optical routing means comprise a first and a second optical filter intended to eliminate portions of said fluorescence light flux that are emitted at the first wavelength and at the second wavelength, respectively;
the first and the second optical filter are high-pass filters having, respectively, a first cut-off frequency equal to 320 nm and a second cut-off frequency equal to 455 nm;
said spectrofluorometer includes a system for moving the light excitation means, adapted to adjust the position of said study zone on the object and/or the orientation of said excitation light beam with respect to the object;
said spectrofluorometer includes a mechanical system for the translational and/or rotational positioning of the optical routing means, to maximize the florescence light flux collected;
the moving system and the mechanical positioning system are integrated into a measuring head, wherein means for controlling said measuring head are provided;
the optical routing means include an optical fibre to route said fluorescence light flux collected towards said optical spectrometer;
means for time multiplexing the light beams generated by each of the two electroluminescent diodes are provided, and said optical spectrometer is adapted to process a multiplexed fluorescence light flux.

The invention finds applications in the fields of art, for the pigments and binders identification, of conservation for the study of the material alterations but also the physico-chemical properties of the surfaces and interfaces, the powders, the textiles, the fibres, the finely divided or granular samples, the minerals (stones at the surface), the plants, the biological tissues and even the liquids at the surface or in depth under a few millimetres of depth.

The main domain contemplated for the invention is that of art for the characterization and the study of the pigments and binders used in paintings, but also for the artwork conservation by the study of the material alterations.

Hence, in a particularly advantageous manner, the optical spectrometer of the spectrofluorometer according to the invention delivers a fluorescence signal representative of the light spectrum of said fluorescence light flux, and said spectrofluorometer includes computer means adapted to process said fluorescence signal to identify at least one chemical compound present in said study zone of the analysed object.

Preferably, said computer means include a database register comprising a plurality of reference light spectra each associated with a particular chemical compound, said identification of at least one chemical compound by said computer means being made by comparison of the light spectrum of said fluorescence light flux with at least one other reference light spectrum.

One of the advantages of this spectrofluorometer lies in its use for the study of the chemical compounds, such as the pigments for example.

Its coupling to a database register allows identifying rapidly on the light spectrum obtained the nature of the pigment(s) present in the study zone of the object illuminated by the excitation light flux.

The spectrofluorometer according to the invention may also allow in certain embodiments acquiring reflection spectra in addition to the fluorescence spectra.

The invention finally relates to a method of identification of a chemical compound present in the study zone of an object to be analysed by means of a spectrofluorometer according to the invention, including the steps of:

a) illuminating said study zone of the object by means of said excitation light flux;

b) collecting and routing, thanks to said optical routing means, said fluorescence light flux emitted by said excited study zone towards said optical spectrometer for the analysis of the light spectrum of said flux;

c) processing, thanks to said computer means, said fluorescence signal representative of the light spectrum of said fluorescence light flux; and

d) identifying, based on the processing of step c), at least one chemical compound present in said study zone of the object analysed.

Advantageously, when the spectrofluorometer includes computer means comprising a database register, the identification of said chemical compound at step d) is made by comparing said light spectrum of said fluorescence light flux with at least one other reference light spectrum of said database register of the computer means of the spectrofluorometer.

The following description, with reference to the appended drawings, given by way of non-limitative example, will permit to understand in what consists the invention and how it may be made.

In the appended drawings:

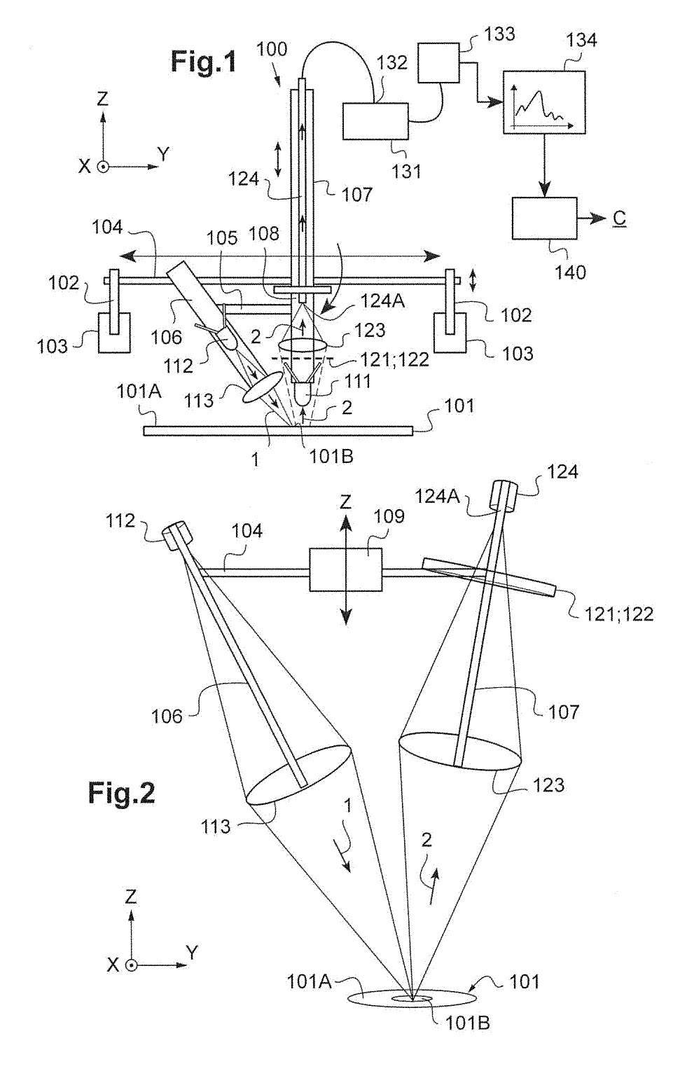

FIG. 1 is a schematic view of a spectrofluorometer according to the invention with two electroluminescent diodes;

FIG. 2 is a schematic diagram explaining the operation of the focusing lenses for the excitation and the collection;

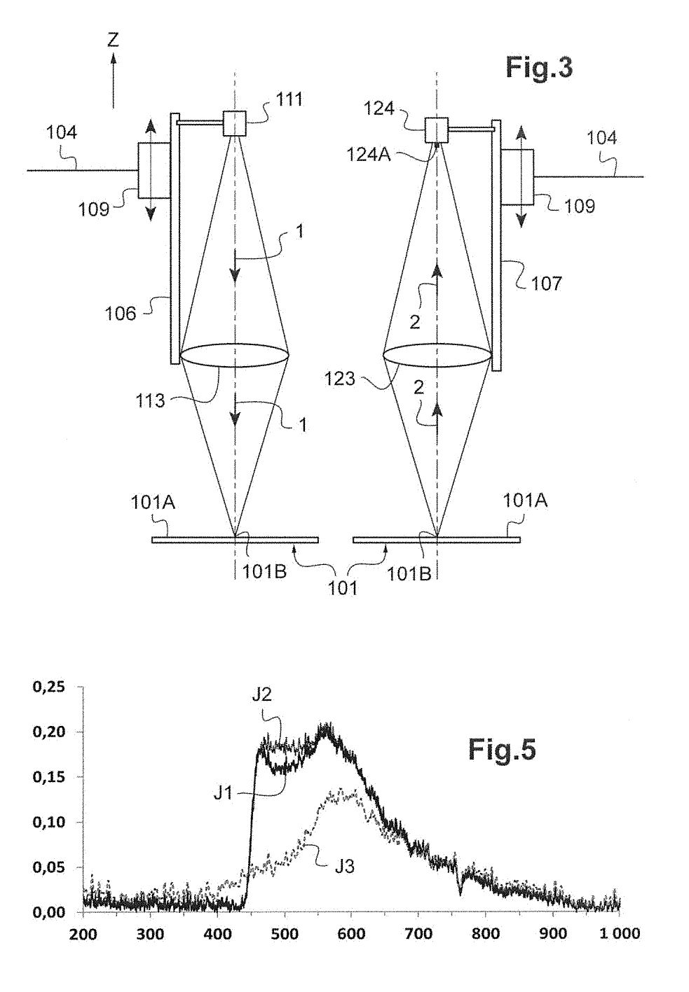

FIG. 3 is a side view of FIG. 2 when one of the electroluminescent diodes integrates an internal focusing lens;

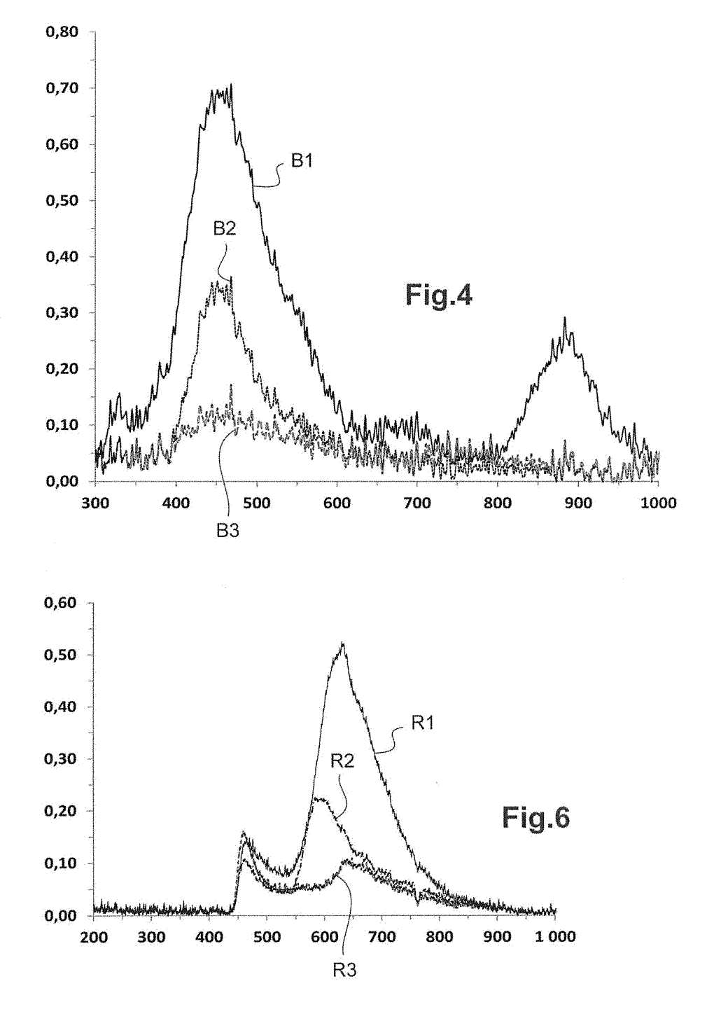

FIGS. 4 to 6 are curves representing the fluorescence signal as a function of the wavelength obtained thanks to the spectrofluorometer of FIG. 1, for three pigments, blue, yellow and red, respectively, and

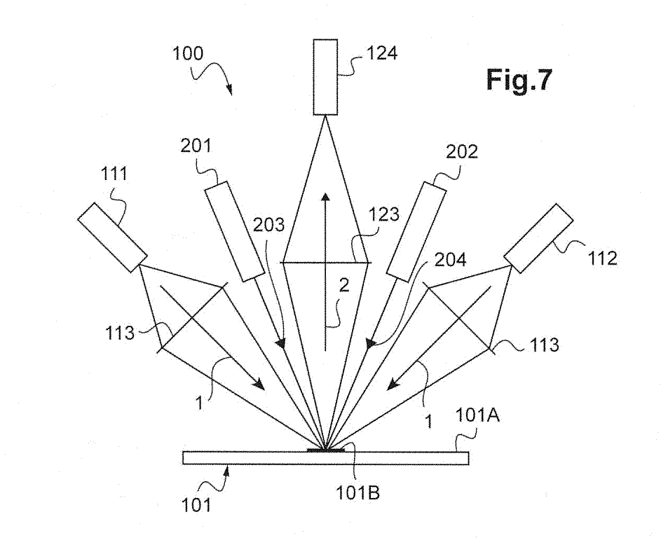

FIG. 7 is a schematic diagram of a variant embodiment of a spectrofluorometer according to the invention.

In FIG. 1 is shown a spectrofluorometer 100 according to a particular embodiment of the invention.

This spectrofluorometer 100 is intended for analysis of an object 101, herein substantially planar, on a top surface 101A of which is present a layer of material.

The spectrofluorometer 100 operates as follows. An excitation light beam 1 is directed towards the surface 101A of the object 101, on a study zone 101B of the object 101 that is desired to be analysed.

This excitation light beam 1 will be absorbed by the different constituents of the layer of materials, which will in turn emit a fluorescence light flux 2.

The fluorescence light flux 2 is collected and sent to an optical spectrometer 131 connected to a processing means 133, for example a computer, which delivers a signal representative of the light spectrum 134 of the fluorescence light flux 2.

The analysis of this light spectrum 134 allows identifying the constituent(s) of the layer of materials present at the surface 101A of the object 101.

By moving the study zone 101B on this surface 101A, information about the distribution of the constituents in the object 101 is hence obtained.

The different elements of the spectrofluorometer 100 of FIG. 1 will now be described in detail.

In order to produce the excitation light beam 1, the spectrofluorometer 100 first includes light excitation means adapted to illuminate the study zone 101B of the object 101 with the excitation light beam 1.

According to an advantageous characteristic of the invention, these light excitation means comprise two electroluminescent diodes: a first electroluminescent diode 111 and a second electroluminescent diode 112.

The first electroluminescent diode 111 is an ultraviolet diode (or “UV diode”) that emits at a first wavelength, noted λ1, comprised between 250 and 300 nanometres (nm). Herein, this first wavelength λ1 is equal to 285 nm. This first electroluminescent diode 111 is particularly adapted to the study of the fluorescence of the organic binders as the gum Arabic or the protein glues, or for example that of the blue pigments as the lapis-lazuli, the azurite or the “Egyptian blue”.

The second electroluminescent diode 112 is preferably a diode emitting in a wavelength range comprised between 300 and 500 nm. Herein, this second electroluminescent diode 112 emits at a second wavelength, noted λ2, which is equal to 375 nm.

This second electroluminescent diode 112 is adapted to the study of the fluorescence of the lipidic binders as egg yolk or linseed oil, or the yellow (orpiment, lead and tin yellow, . . . ) or red (minimum, cinnabar, cochineal, . . . ) pigments.

The first electroluminescent diode 111 has preferably a mean light power lower than 100 milliwatts (mw), still more preferably lower than 10 mW. This light power is herein of 0.5 mW.

Likewise, the second electroluminescent diode 112 has preferably a mean light power lower than 100 milliwatts (mw), still more preferably lower than 10 mW. This light power is herein equal to about 5 mW and is distributed as a cone of emission of apical angle equal to 10°.

The low power of the electroluminescent diodes allows not damaging the surface of the object with an excitation light beam of too high power, which is critical during the study of fragile artworks.

Advantageously, the powers of the electroluminescent diodes are adapted, on the one hand, so that the fluorescence light flux 2 has a sufficient level to be correctly detected by the optical spectrometer 131, for example with a good signal-to-noise ratio; and on the other hand, so that the thermal load, i.e. the heat, deposited on the study zone 101B does not exceed a predetermined damaging threshold, for example a melting threshold in the case of a painting.

Preferably, the first electroluminescent diode 111 and the second electroluminescent diode 112 are cell-operated or battery-operated. This allows freeing from the need to use an additional power-supply device that would make the spectrofluorometer heavier and more complex.

As a variant, the electroluminescent diodes may be power supplied via the USB port of a battery-operated portable electronic device, for example a computer of the portable type, a tablet or a mobile phone.

In another embodiment, the spectrofluorometer could include more than two electroluminescent diodes as a function of the type of object to be analysed. For example, it could be provided to use a third electroluminescent diode emitting in a wavelength range comprised between 440 nm and 500 nm, for the study of the fluorescence of the yellow organic pigments.

Preferably, the spectrofluorometer can provide the use of 2 to 30 electroluminescent diodes, which may include in particular electroluminescent diodes emitting in the infrared and/or in the ultraviolet.

To gain in compactness in the implementation of the spectrofluorometer with several electroluminescent diodes, it may be provided to replace an electroluminescent diode by another one by positioning it at the same place, for example by means of a mechanical and/or electrical positioning system of the wheel, barrel or translation plate type, operated manually or with a software-controlled servomotor.

As shown in FIG. 1, the first electroluminescent diode 111 is mounted on a first arm 108 of the spectrofluorometer 100, to which is also connected a second arm 106 thanks to a bridge 105 fastening the two arms 106, 108 to each other.

The second arm 106, which carries the second electroluminescent diode 112, is oriented so that the light beam generated by the latter is inclined with respect to the surface 101A of the object 101.

The spectrofluorometer 100 moreover includes a system for moving the light excitation means.

More particularly herein, two vertical poles 102 of axis Z are provided (see FIG. 1), connected to each other by means of a horizontal cross-bar 104 of axis Y and two bases 103 in which the two poles 102 are mounted mobile in translation along the axis Z, so that the distance from the cross-bar 104 to the surface 101A of the object 101 varies.

It is also provided a beam, horizontal along the axis X, and an element (not visible in FIG. 1) for connecting this beam to the cross-bar 104 that is adapted to slide along the latter for a translation of the beam in a direction parallel to the axis Y.

On this beam is moreover fixed the first arm 108 of the spectrofluorometer 100, so that, thanks to the moving system herein comprising the poles 102, the bases 103, the cross-bar 104, the beam and the connection element, the first arm 108 and the second arm 106 of the spectrofluorometer 100 are mobile with respect to the object 101.

That way, it is then possible to adjust the position of the study zone 101B on the object 101.

As a variant, other moving means could also be provided to adjust the orientation of the excitation light beam with respect to the object and other supports (camera foot, boom . . . ).

In a particular embodiment shown in FIG. 7, it could be provided to equip the spectrofluorometer 100 with a positioning indicator including two lasers 201, 202 emitting two visible laser beams 203, 204, respectively, crossing each other at the surface 101A of the sample 101, at the study zone 101B, when the spectrofluorometer 100 is at an optimum distance of its surface 101A.

As another variant, it is also possible to include an optical positioning system comprising for example a camera or a microscope, this optical positioning system allowing a lateral positioning, i.e. in the plane of the sample surface, of the spot of analysis on the sample.

This optical positioning system is intended to remotely target the sample surface, with or without magnification, with or without auxiliary lighting means distinct from the electroluminescent diodes.

In another embodiment, the spectrofluorometer includes a foot, of the camera-foot or tripod type, and a translation bar on which is positioned a millimetric approach plate in X, Y and Z.

Although not shown in FIG. 1, it is herein provided a switch allowing lighting alternately the first electroluminescent diode 111 and the second electroluminescent diode 112.

In this configuration, the excitation light beam 1 is then formed either by the light beam generated by the first electroluminescent diode 111, or by the light beam generated by the second electroluminescent diode 112.

As a variant, the spectrofluorometer may include a program allowing launching the successive lighting of the diodes by a single click.

In another embodiment, not shown, the switch may be replaced by means for time multiplexing the light beams generated by each of the two electroluminescent diodes. These time multiplexing means may for example include optical means adapted to pulse at least one diode and to modulate the light flux emitted by the latter. In this case, the fluorescence light flux 2 is itself multiplexed so that it is necessary to use an optical spectrometer 131 adapted to process a multiplexed light flux.

In another embodiment, the switch is replaced by pulse control means allowing the electroluminescent diodes to be lighted, together or successively, in a pulsed manner, i.e. with short durations of emission. Such pulse control means may comprise, for example, pulsed-current power supplies. This scheme of control of the electroluminescent diodes offers an interest either to eliminate the measurement noise, or to measure the fluorescence lifetimes.

These optical, electrical or electronic devices used for multiplexing or pulsing the light fluxes emitted may be programmable. This allows in particular making analysis on different objects in desired experimental conditions and according to a protocol adapted to the study of these objects.

In particular, the pulsed irradiation allows preventing the heat damages that could be caused to the study zone 101B of the object 101 probed by the excitation light beam 1.

As shown in FIG. 1, the light excitation means comprise a first focusing lens 113 arranged in the second arm 106 of the spectrofluorometer 100, downstream from the second electroluminescent diode 112.

This first focusing lens 113 is intended to focus the excitation light beam 1 to the surface 101A of the object 101. The aperture and focal length thereof are determined so as, on the one hand, to collect the major part of the light flux radiated by the second electroluminescent diode 112, and on the other hand, to focus the excitation light beam 1 to a study zone 101B whose size is of the order of 1 mm diameter (see FIG. 2).

The first electroluminescent diode 111 is itself of the integrated lens type, so that an additional focusing lens is not necessary to obtain a good focusing on the object 101.

We will now describe, with reference to FIGS. 1 and 2, the optical routing means that collect the fluorescence light flux 2 emitted by the study zone 101B excited by the excitation light beam 1 to route this fluorescence light flux 2 towards the optical spectrometer 131 in order to analyse the light spectrum thereof.

These optical routing means herein comprise an optical fibre 124 in which is transported the fluorescence light flux 2 up to an entry 132 of the optical spectrometer 131.

This optical fibre 124 is herein an optical fibre of 400 micrometre diameter. It has a fibre entry 124 through which the fluorescence light flux 2 is injected.

Nevertheless, given that the numerical aperture at the entry of such an optical fibre 124 is generally low, the fluorescence light flux 2 must be focused to the fibre entry 124A.

Hence, as schematically shown in FIG. 2, the optical routing means comprise a second focusing lens 123, upstream from the optical fibre 124 to focus the fluorescence light flux 2 collected to the fibre entry 124.

Just as for the first focusing lens 113, the aperture (i.e. the diameter) and the focal length of this second focusing lens 123 are determined so as, on the one hand, to collect the greatest portion of the fluorescence light flux 2 emitted by the study zone 101B excited by the excitation light beam 1, and on the other hand, to focus the fluorescence light flux 2 to the fibre entry 124A of the optical fibre 124.

The positioning of the different optical elements of the spectrofluorometer 100 is relatively critical for the measurement sensitivity, so that the positioning of the optical fibre 124 and of the second focusing lens 123 both relative to each other and relative to the study zone 101B of the object 101 must be made accurately.

So, as shown in FIG. 1, the spectrofluorometer 100 includes preferably a mechanical system for the translational and/or rotational positioning of the optical routing means, to maximize the florescence light flux 2 collected by the optical routing means and transmitted to the optical spectrometer 131, herein via the optical fibre 124.

The mechanical positioning system herein comprises, besides the poles 102, the bases 103 and the cross-bar 104 of the system for moving the excitation light beam, a support 107 mounted on the cross-bar 104 and a 3-axis translation plate (109, see FIG. 2) with a fine adjustment arranged between the cross-bar 104 and the support 107, so as to be able to adjust the position of the fibre entry 124A with respect to the second focusing lens 123 and hence to obtain a maximum fluorescence signal.

This positioning system is connected to a table support, which may be a sliding beam, an articulated arm, robotized or manually controlled.

The two rails 106, 108 and the bridge 105 define between them a planar triangle such that the lower apex thereof is on the top surface 101A of the object 101, thanks to the Z adjustment of the plate 109.

The adjustment necessary to obtain a good measurement may be made manually, through a wheel of the plate 109, or automatically in the case of a motorized system.

In the case where the first electroluminescent diode 111 integrates an internal focusing lens (case of FIG. 3, side view), the device is similar but with shorter diode-lens and lens-object distances.

In a possible variant, the moving system and the mechanical positioning system are integrated into a measuring head, which is piloted, for example in an automated manner, by control means.

Advantageously, and as shown in FIGS. 1 and 2 (in which only one filter is shown), the optical routing means also comprise two optical filters: a first optical filter 121 associated with the first electroluminescent diode 111 and a second optical fibre 122 associated with the second electroluminescent diode 112.

More generally, the optical routing means may comprise a number of optical filters lower than or equal to the number of electroluminescent diodes.

These optical filters 121, 122 have for function to eliminate a portion of the fluorescence light flux 2 that is emitted at the first wavelength λ1 and at the second wavelength λ2, respectively.

Indeed, the excitation light beam 1 is partially absorbed in the study zone 101B of the object 101 and a non-negligible portion of this beam is reflected by the top surface 101A of this object 101, so that a reflected light beam, at the first or at the second wavelength as a function of which of the electroluminescent diodes 111, 112 is lighted, is superimposed onto the fluorescence light flux 2.

With no particular precaution, this reflected light beam is transported up to the optical spectrometer 131, with the result that the fluorescence signal is skewed.

The optical filters 121, 122 used are hence intended to reject the light flux at the first and second wavelengths λ1, λ2 coming at the fibre entry 124A in such a manner that the light spectrum measured by the optical spectrometer 131 is not polluted by this spurious flow.

Generally, any optical fibre allowing filtering a wavelength or a wavelength band substantially centred to one of the two wavelengths in question may suit.

In the embodiment described herein, the first optical filter 121 and the second optical filter 122 are high-pass filters having a first cut-off frequency, noted fc1, equal to 320 nm and a second cut-off frequency, noted fc2, equal to 455 nm, respectively.

These two optical filters 121, 122 allow both eliminating the spurious reflection at the wavelength of the electroluminescent diode and not too-highly spatially cutting the fluorescence light flux 2 in the wavelengths of interest.

As a variant, the two optical filters could be bandpass filters, for example centred around wavelengths of 285 nm and 375 nm, and having a spectral width of 10 to 20 nm.

As another variant, the first optical filter is a high-pass filter having a first cut-off frequency, equal to 320 nm to 320 nm, and the second optical fibre is a high-pass filter having a second cut-off frequency that is function of the second wavelength λ2.

The spectrofluorometer described hereinabove satisfies the requirements of the application aiming to detect and measure the spectrofluorescence on artworks that require a contactless measurement and the shortest possible time of exposure. The duration of measurement for the spectrofluorometer of the invention is generally comprised between 1 and 50 seconds.

Thanks to the moving and positioning systems, the positioning is made in a few seconds, typically less than 10 s, and the measurement acquired in a few seconds after the electroluminescent diodes have been powered on.

As the electroluminescent diodes 111, 112 are pre-positioned in the arms 106, 108, the passage from a wavelength to the other is instantaneous by a simple action of the switch.

Thanks to the second focusing lens 123, the maximum of fluorescence light, which may be filtered or not, arrives at the fibre entry 124A, to be redirected towards the entry 132 of the optical spectrometer 131.

The spectrofluorometer 100 according to the invention is well adapted to a sensitive measurement necessary to maximally preserve the fragile and precious artworks, as for example medieval illuminations.

In a particular embodiment, it may moreover be provided to use density filters intended to reduce the quantity of ultraviolet light received by a particularly fragile sample. It may for example be used:
a density of 0.1 that allows a reduction of the received UV of 25%,
a density of 0.3 for a reduction of 50%, and
a density of 0.6 for a reduction of 75%.

These optical density filter may also be at least in part magnetized, for example at the periphery thereof if they are filters with a disc shape, so that they can be superimposed to each other in order to further reduce the ultraviolet light received by the surface of the sample.

The spectrofluorometer is portable, light-weight and of reduced cost.

Advantageously, the spectrofluorometer 100 includes computer means 140 that process a signal representative of the light spectrum of the fluorescence light flux 2 delivered by the optical spectrometer 131 (see FIG. 1).

The processing of the representative signal by the computer means 140 allows identifying at least a chemical compound C liable to be present in the study zone 101B of the object 101 that is in course of analysis.

Preferentially, the computer means 140 include a database register (not shown) comprising a plurality of reference light spectra, each reference light spectrum being associated with a particular chemical compound whose fluorescence spectrum in the interesting wavelength range is accurately known.

Thanks to this database register, the identification of a chemical compound C by the computer means 140 is then made by comparing the light spectrum of the fluorescence light flux 2 with at least one other reference light spectrum, preferentially with a plurality of reference light spectra, or even with the totality of spectra recorded in the database register.

### EXAMPLES

We will now describe, with reference to FIGS. 4 to 6, a method of identification of a chemical compound by means of the above described spectrofluorometer 100.

In a first step of the method of identification according to the invention, the study zone 101B of the object 101 is illuminated by means of the excitation light flux 1. That is in this study zone 101B of the object 101 to be analysed that the presence of the chemical compound is searched for.

So illuminated by the light excitation means 111, 112, 113, the study zone 101B emits the fluorescence light flux 2, this fluorescence light flux 2 being a function in particular of the nature of the chemical compounds that are excited by the excitation light flux and that fluoresce in response to this excitation.

In a second step, this fluorescence light flux 2 is then collected and routed thanks to the optical routing means 121, 122, 123, 124 towards the optical spectrometer 131 for the analysis thereof.

As shown in FIG. 1, the optical spectrometer 131 then delivers a fluorescence signal 134 that is representative of the light spectrum of the fluorescence light flux 2.

Different curves representing the fluorescence signal 134 delivered by the processing means 133 of the optical spectrometer 131 are shown in FIGS. 3 to 5.

On each curve, are represented in abscissa the wavelength of the fluorescence spectrum and, in ordinate, the value, in arbitrary unit, of the fluorescence light flux at the considered wavelength.

A way to read these curves is to spot the different characteristic wavelengths for which the value of the fluorescence light flux has a local or global maximum. It is then talked about “peaks” in the fluorescence signal emitted by the object.

As a function of the position of the characteristic wavelengths in the measured light spectrum, it is possible, if reference spectra are known, to identify which constituents are analysed in the study zone of the object.

The curve of FIG. 3 hence corresponds to the fluorescence signal obtained thanks to the above described spectrofluorometer 100 by analysing three different objects on the surface of which a blue pigment had been deposited, mixed with gum Arabic, and by using the first electroluminescent diode 111 emitting at 285 nm and the first optical filter 121 cutting at 320 nm.

The curve of FIG. 4 corresponds to the fluorescence signal obtained by analysing three different objects on the surface of which a yellow pigment had been deposited, and by using the second electroluminescent diode 112 emitting at 375 nm and the second optical filter 122 cutting at 455 nm.

The curve of FIG. 5 hence corresponds to the fluorescence signal obtained by analysing three different objects on the surface of which a red pigment had been deposited, mixed with gum Arabic, and by using the second electroluminescent diode 112 emitting at 375 nm and the second optical filter 122 cutting at 455 nm.

In FIG. 4, the following observations can be done:
the curve noted B1 has a first peak at a wavelength of about 460 nm, characteristic of the gum Arabic, and a second peak at a wavelength of about 890 nm, corresponding to a blue pigment called “Egyptian blue”;
the curve noted B2, which corresponds to azurite, has the same first peak at 460 nm, characteristic of the gum Arabic, but no second peak is observed;
the curve noted B3 has also the peak due to the gum Arabic and another, very low peak, around 790 nm, corresponding to a blue pigment that is indigo.

In FIG. 5 are shown the fluorescence signals of the orpiment (curve J1), of the lead and tin yellow and of the yellow ochre (curve J3). Herein, only the curve J3 corresponding to yellow ochre stands out, with a characteristic fluorescence peak located around 590 nm. The orpiment (curve J1) and the lead and tin yellow have a peak around about 560 nm.

In FIG. 6, we find for each of the three curves R1, R2, R3, the characteristic peak of the gum Arabic around 460 nm.

We also find:
for the curve noted R1: a second, very high peak at a wavelength of about 630 nm, corresponding to a red pigment called “Brazil wood”;
for the curve noted R2: a second peak at a wavelength of about 590 nm, corresponding to a red pigment that is minimum;
for the curve noted R3: a second peak at a wavelength of about 640 nm, corresponding to a red pigment of the cochineal type.

It will moreover be noted that, on each of these curves, the fluorescence signal is not interfered by to the light spectrum of emission of the electroluminescent diodes.

These different curves have been compared to those obtained with a spectrofluorometer of the market (FluoroLog 2 of the Horiba Jobin Yvon Company) and comparable results have been obtained.

In a third step of the method of identification, the fluorescence signal is hence processed by the computer means 140 that identify, in a last step, from this processing, at least one chemical compound C present in the study zone 101B of the analysed object 101.

This identification is herein made for the three above-described examples by comparing the light spectra J1, J2, J3; B1, B2, B3; R1, R2, R3 of the fluorescence light flux 2 with at least one other reference light spectrum of the database register of the computer means 140.

These reference light spectra are in particular characterized by the presence of fluorescence peaks at different wavelengths specific to certain chemical compounds.

As described hereinabove, the recognition of a peak in the light spectrum for a given wavelength then allows identifying in the study zone 101B the presence of a chemical compound C whose reference light spectrum recorded in the database register comprises such a peak around this wavelength.

Advantageously, the database may also be enriched with the measured fluorescence light spectra thanks to the spectrofluorometer of the invention.

It is also possible thanks to the database register to identify mixtures of different chemical compounds present in the study zone of the object analysed. This is particularly adapted for the analysis of an object combining different supports, pigments or binders.

The spectrofluorometer of the invention is portable, light-weight and of reduced cost. It is moreover evolving. Its architecture allows approaching at the closest the object to be analysed. The measuring head of this spectrofluorometer may be carried by a robotized arm, for example, or a table support of the beam type, in order to fly over the object at a constant and adjusted distance.

The spectrofluorometer of the invention has hence the advantage to avoid any contact with the object to be measured.

The present invention is not limited in any way to the embodiment described and shown, but the one skilled in the art will be able to apply thereto any variant within the scope thereof.

1-15. (canceled)

16. A spectrofluorometer (100) for analysis of an object (101), the spectrofluorometer (100) comprising:
light excitation means (111, 112, 113) adapted to illuminate a study zone (101B) of said object (101) with an excitation light beam (1); and
optical routing means (121, 122, 123, 124) adapted to collect a fluorescence light flux (2) emitted by said study zone (101B) excited by the excitation light beam (1) and to route said fluorescence light flux (2) towards an optical spectrometer (131) for analysis of the light spectrum (J1, J2, J3; B1, B2, B3; R1, R2, R3) of said fluorescence light flux (2),
wherein the light excitation means (111, 112, 113) comprise a first electroluminescent diode (111) and a second electroluminescent diode (112), the first electroluminescent diode (111) emitting at a first wavelength (λ1) comprised between 250 and 300 nm and said excitation light beam (1) being formed by one and/or the other light beam generated by each electroluminescent diode (111, 112).

17. The spectrofluorometer (100) according to claim 16, wherein said second electroluminescent diode (112) emits at a second wavelength (λ2) comprised between 300 and 500 nm.

18. The spectrofluorometer (100) according to claim 16, wherein said light excitation means (111, 112, 113) comprise a first focusing lens (113) to focus said excitation light beam (1) to a surface (101A) of said object (101).

19. The spectrofluorometer (100) according to claim 16, wherein said optical routing means (121, 122, 123, 124) comprise a second focusing lens (123) to route the fluorescence light flux (2) collected towards an entry (132) of said optical spectrometer (131).

20. The spectrofluorometer (100) according to claim 16, wherein said optical routing means (121, 122, 123, 124) comprise a first optical filter (121) and a second optical filter (122) intended to eliminate, respectively, portions of said fluorescence light flux (2) that are emitted at the first wavelength (λ1) and at the second wavelength (λ2), respectively.

21. The spectrofluorometer (100) according to claim 20, wherein the first (121) and the second (122) optical filter are high-pass filters having, respectively, a first cut-off frequency (fc1) equal to 320 nm and a second cut-off frequency (fc2) equal to 455 nm.

22. The spectrofluorometer (100) according to claim 16, further comprising a moving system (102, 103, 104) for moving the light excitation means (111, 112, 113), adapted to adjust a position of said study zone (101B) on the object (101) and/or the orientation of said excitation light beam (1) with respect to the object (101).

23. The spectrofluorometer (100) according to claim 22, further comprising a mechanical system (102, 103, 104, 107) for at least one of translational positioning and rotational positioning of the optical routing means (121, 122, 123, 124), to maximize the florescence light flux (2) collected.

24. The spectrofluorometer (100) according to claim 23, wherein the moving system and the mechanical positioning system are integrated into a measuring head, and wherein means for controlling said measuring head are provided.

25. The spectrofluorometer (100) according to claim 16, wherein the optical routing means (121, 122, 123, 124) include an optical fibre (124) to route said fluorescence light flux (2) collected towards said optical spectrometer (131).

26. The spectrofluorometer (100) according to claim 16, wherein means for time multiplexing the light beams generated by each of the two electroluminescent diodes are provided, and wherein said optical spectrometer (131) is adapted to process a multiplexed fluorescence light flux (2).

27. The spectrofluorometer (100) according to claim 16, wherein said optical spectrometer (131) delivers a fluorescence signal (134) representative of the light spectrum (J1, J2, J3; B1, B2, B3; R1, R2, R3) of said fluorescence light flux (2) and including computer means (140) adapted to process said fluorescence signal (134) to identify at least one chemical compound (C) present in said study zone (101B) of the analysed object (101).

28. The spectrofluorometer (100) according to claim 27, wherein said computer means (140) include a database register comprising a plurality of reference light spectra each associated with a particular chemical compound, said identification of at least one chemical compound (C) by said computer means (140) being made by comparison of the light spectrum (J1, J2, J3; B1, B2, B3; R1, R2, R3) of said fluorescence light flux (2) with at least one other reference light spectrum.

29. A method of identification of a chemical compound (C) present in a study zone (101B) of an object (101) to be analysed by means of a spectrofluorometer (100) according claim 27, comprising steps of:
a) illuminating said study zone (101B) of the object (101) by means of said excitation light flux (1);
b) collecting and routing, using said optical routing means (121, 122, 123, 124), said fluorescence light flux (2) emitted by said excited study zone (101B) towards said optical spectrometer (131) for the analysis of the light spectrum (J1, J2, J3; B1, B2, B3; R1, R2, R3) of said flux (2);
c) processing, with said computer means (140), said fluorescence signal (134) representative of the light spectrum (J1, J2, J3; B1, B2, B3; R1, R2, R3) of said fluorescence light flux (2); and
d) identifying, based on the processing of step c), at least one chemical compound (C) present in said study zone (101B) of the object (101) analysed.

30. A method of identification of a chemical compound (C) present in a study zone (101B) of an object (101) to be analysed by means of a spectrofluorometer (100) according to claim 28, comprising steps of:
a) illuminating said study zone (101B) of the object (101) by means of said excitation light flux (1);
b) collecting and routing, using said optical routing means (121, 122, 123, 124), said fluorescence light flux (2) emitted by said excited study zone (101B) towards said optical spectrometer (131) for the analysis of the light spectrum (J1, J2, J3; B1, B2, B3; R1, R2, R3) of said flux (2);
c) processing, using said computer means (140), said fluorescence signal (134) representative of the light spectrum (J1, J2, J3; B1, B2, B3; R1, R2, R3) of said fluorescence light flux (2); and
d) identifying, based on the processing of step c), at least one chemical compound (C) present in said study zone (101B) of the object (101) analysed.

31. The method of identification according to claim 29, wherein, at step d), the identification of said chemical compound (C) is made by comparing said light spectrum (J1, J2, J3; B1, B2, B3; R1, R2, R3) of said fluorescence light flux (2) with at least one other reference light spectrum of said database register of the computer means (140) of the spectrofluorometer (100).

32. The spectrofluorometer (100) according to claim 16, further comprising a mechanical system (102, 103, 104, 107) for at least one of translational positioning and rotational positioning of the optical routing means (121, 122, 123, 124), to maximize the florescence light flux (2) collected.

33. The spectrofluorometer (100) according to claim 1, wherein said excitation light beam (1) is formed by the light beams generated by both the first electroluminescent diode (111) and the second electroluminescent diode (112).
